(19) United States
(12) Patent Application Publication
(10) Pub. No.: US 2006/0146642 A1
(43) Pub. Date: Jul. 6, 2006

(54) Extruder, specifically an extrusion welding device

(76) Inventors: Christian Peters, St. Ingert (DE); Adolp Niederberger, Kaegiswil (CH); Guiseppe Di Miceli, Menziken (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/266,411

(22) Filed: Nov. 3, 2005

(30) Foreign Application Priority Data
Jan. 5, 2005 (DE) 202005000130.9

(51) Int. Cl. B29B 7/42

(52) U.S. Cl. 366/89; 366/90

(57) ABSTRACT

The invention concerns an extruder, specifically a hand-held extrusion welding device. For the purpose of degassing a synthetic material to be extruded that is already partially plasticized in the extruder, the invention proposes a thread-less area between two screw threads of an extruder screw. The compression of the synthetic material to be extruded expels gas from the synthetic material, the expelled gas flows against the feeding direction, and exits from the extruder at a feed opening. The extruder proposed by the invention offers the advantage of a complete, or at least an almost complete, degassing of the plasticized synthetic material.

### TECHNICAL FIELD

The invention concerns an extruder, specifically an extrusion welding device, with an extruder housing and a power-driven extruder screw rotating in the extruder housing.

### BACKGROUND OF THE INVENTION

Such extruders, in particular in the shape of hand-held devices, are commonly used for welding thermoplastic synthetic materials. The extruder housing is usually of tubular shape with a circular cross-section. Essentially, the powered rotating extruder screw has the functions of feeding and compressing the synthetic material to be extruded, of homogenizing (mixing, kneading) and thereby plasticizing it, and of extruding it from a nozzle. Also, solid and liquid additives such as dyes and fillers, stabilizers and lubricants are mixed homogeneously with the synthetic material to be extruded by the powered rotation of the extruder screw. It is a familiar feature of extruder welding devices that the synthetic material to be extruded is supplied as a granulate or wire (plastic welding wire) and is plasticized in the extruder. Such a wire is also known as a (plastic) rope or strand. The supplied wire is commonly chopped into pieces before it is plasticized. The air in between the plastic pieces can be pulled into the synthetic material during the mixing, kneading, and plasticizing in the form of gas bubbles, which is undesirable and to be prevented.

### SUMMARY OF THE INVENTION

The invention addresses the problem of proposing an extruder with a good degassing effect that avoids gas inclusions in the plasticized compound, or at least reduces them to a minimum.

The invention solves this problem with the characteristics of claim 1. The extruder screw of the extruder proposed by the invention has two axially spaced screw threads. That means that the screw thread of the extruder screw is not continuous but that the extruder screw has a thread-less axial area between its screw threads. The thread-less area forms a buffer zone that serves as a storage space for the not yet completely plasticized compound, on the one hand, and as a degassing zone, on the other hand. Gas, in particular air, included in the synthetic material that is to be extruded but not completely plasticized yet, is expelled against the feeding direction from the synthetic material by the increasing compression of the not yet fully plasticized synthetic material, and flows from the thread-less buffer zone against the feeding direction of the extruder back to an inlet or feed opening for the synthetic material. In the area of the screw thread of the extruder screw that comes first in relation to the feeding direction, the synthetic material to be extruded is still present in the form of pieces that may already be partially plasticized and fused together. In the area of the screw thread of the extruder screw that comes first in relation to the feeding direction, the density of the synthetic material is still low enough to leave sufficient space between the synthetic material pieces for the air displaced in the buffer zone to escape against the feeding direction, i.e. towards the fill or feed end of the extruder. The buffer zone without a screw thread between the two screw threads of the extruder screw of the extruder proposed by the invention has the effect of degassing the synthetic material to be extruded against the feeding direction of the extruder. Gas inclusions in the plasticized synthetic material exiting from the extruder are avoided completely, or at least to a very large extent.

Screw thread of the extruder screw, in the terms of the invention, means the screw thread serving to compress, homogenize, and plasticize, i.e. the actual extruder screw. It does not mean the—also screw-shaped—chopping threads or feeding threads that may be located in front of the extruder screw but do not serve for the actual extruding and plasticizing process. Preferably, the extruder screw consists of one piece, but may also be made of several pieces.

Another advantage of the extruder screw proposed by the invention is that it allows the use of a simple extruder insert, also known as an extruder nozzle. With the extruder screw proposed by the invention, it is not necessary to use a special extruder insert with multiple deflection of the plasticized synthetic material, possibly even in radial direction, or to separate the plasticized synthetic material in the extruder into several strands by means of a perforated disk, etc. Such special extruder inserts are used in familiar extruders for homogenization, mixing, and pressurizing. Such special extruder inserts are chicanes for the plasticized synthetic material; they have dead zones, i.e. zones with low or zero feeding velocity of the plasticized synthetic material where the synthetic material gets caught for long periods and decomposes. Particles of decomposed synthetic material will then lead to faults in the extruded synthetic compound.

In order to compress the compound to be extruded, one design variant of the invention provides for a gap between the extruder housing and a core of the extruder screw to become smaller in the feeding direction. With increasing plastification, the interstices between the initially solid pieces of the synthetic material to be extruded are reduced to zero, and gas is expelled from the increasingly plasticized synthetic material against the feeding direction. In a design variant of the invention, the gap becomes smaller in that area of the extruder screw that comes first in relation to the feeding direction and/or in the buffer zone between the two screw threads of the extruder screw. In the area of the extruder screw that comes last in relation to the feeding direction, the gap between the core of the extruder screw and the extruder housing remains constant because at this point, the gas inclusions have been expelled from the synthetic material and the synthetic material is not compressed any further. The reduction of the gap is achieved in simple fashion by means of an enlargement of the diameter of the core of the extruder screw. In the area of the extruder screw, the extruder housing may consist of a tube or a hollow cylinder, i.e. the extruder screw is located in a cylindrical hole in which it is caused to rotate.

One design variant of the invention provides for a smoothing space in the extruder housing in feeding direction behind the extruder screw and in front of an extruder insert. Preferably, this smoothing space is free of inserts/obstructions. In this smoothing space, an expansion, mixing, and further homogenization of the synthetic material plasticized by the extruder screw takes place. In addition, the smoothing space has the function of a second storage that makes the exit of the plasticized compound from the extruder more uniform and further reduces the pulsation of the exiting synthetic material.

One design variant of the invention provides for a simple extruder insert that tapers like a funnel in the feeding direction. Such an extruder insert that is easy to manufacture and avoids a complex flow path of the plasticized synthetic material, its separation into several strands, expansion in a gap, or similar features is made possible by the extruder screw proposed by the invention. The extruder insert offers favorable flow, minimizes shear forces, and reduces self-heating of the extruded synthetic material to a minimum. As an additional advantage, it has no dead zones where plasticied compound might collect and remain for long periods, and decompose.

A development of this design variant provides for the extruder insert to have no dead zone in the area of its funnel-shaped taper. Thus, the extruder insert has no inserts, additions inside or ahead of it, and no undercuts etc. that might create, in feeding direction, a dead flow zone or a zone of turbulence behind them, i.e. a zone with reduced flow velocity and/or a long dwell time of the plasticized synthetic material. Specifically, a decrease to a low feed velocity dropping towards zero, and/or a long dwell time of the plasticized synthetic material in the funnel-shaped taper of the extruder insert is to be avoided because this poses the danger of a decomposition of the synthetic material.

Specifically, the extruder proposed by the invention is intended to be a hand-held device, with the size and weight of an electric drill, for example, or of a hammer drill in case of a heavy-duty device. The outer shape of the extruder may also resemble that of an electric drill.

Below, the invention is explained in detail with reference to the design variant shown in the figure.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 shows an extruder screw of an extruder proposed by the invention;

FIG. 2 shows an axial cross section of an extruder insert of an extruder proposed by the invention; and

FIG. 3 shows an axial cross section of an extruder proposed by the invention.

### DETAILED DESCRIPTION OF THE INVENTION

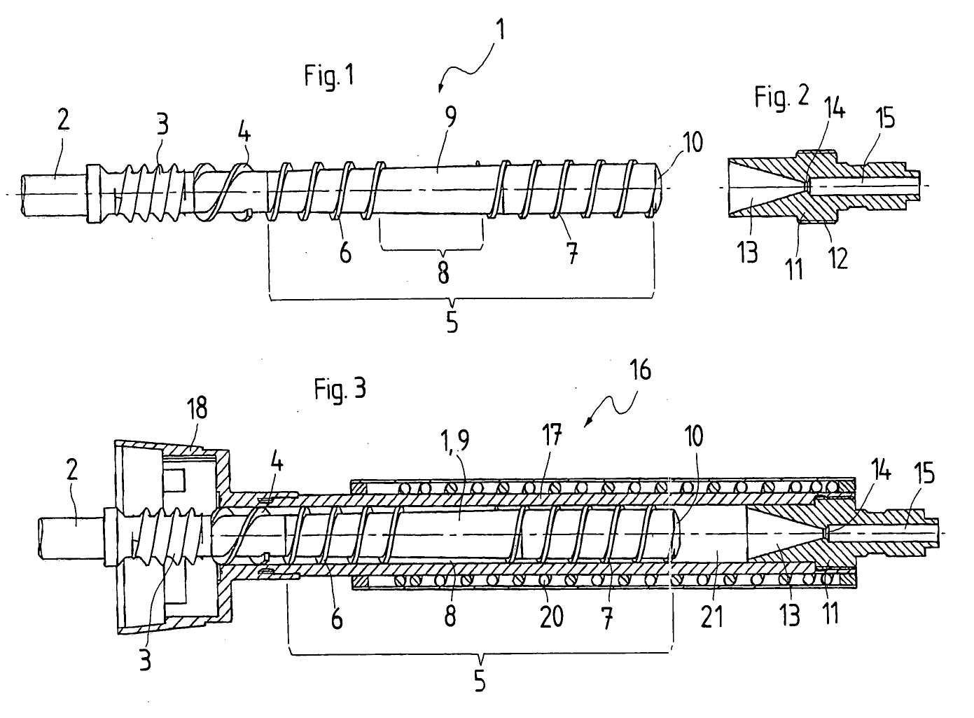

Shown in the figure from left to right, i.e. in the feeding direction, the extruder screw 1 proposed by the invention and shown in FIG. 1 has a drive shaft 2, a feed screw 3, a chopping screw 4, and the actual extruder screw 5. The drive shaft 2 serves to rotate the extruder screw 1, may be cylindrical or conical, and is preferably designed with a profiled cross-section for a positive transfer of the rotary motion. For this purpose, various positive-lock shaft clutches are known that are not described in detail here.

The feed screw 3 has a grooved screw thread with a sawtooth profile. Its purpose is to pull the synthetic material to be extruded. supplied in the shape of a wire (plastic welding wire, also known as rope or strand), into the extruder.

The chopping screw 4 is double-threaded, extending over approximately one thread, i.e. it is relatively short axially, and has a steep pitch. At its front ends in feeding direction, the chopping screw 4 has cutters, cutting the synthetic material to be extruded that is supplied in wire form into pieces which it then conveys to the actual extruder screw 5.

The actual extruder screw 5 takes up most of the length of the extruder screw 1. It has two screw threads 6, 7 that are axially spaced apart. Between the two screw threads 6, 7, there is a thread-free section referred to as buffer zone 8 hereinafter. In the design variant shown here, a screw thread 6 that comes first in relation to the feeding direction has approximately four thread courses, and a screw thread 7 that comes last in relation to the feeding direction has approximately six thread courses. The axial length of the buffer zone 8 corresponds approximately to that of the screw thread 6 that comes first in relation to the feeding direction. In the area of the screw thread 6 that comes first in relation to the feeding direction and of the buffer zone 8, a core 9 of the extruder screw 1 expands conically, and in the area of the screw thread 7 that comes last in relation to the feeding direction, the core 9 of the extruder screw 1 is cylindrical. The exterior diameter of the screw threads 6, 7 is constant, i.e. the height of the thread courses of the screw thread 6 that comes first in relation to the feeding direction is greater than in the screw thread 7 that comes last in relation to the feeding direction. The end surface 10 of the core 9 of the extruder screw 1 is crowned. However, the invention also includes different designs of the extruder screw 1.

The extruder insert 11 shown in FIG. 2 is a turned part made of brass, for example, and has an exterior thread 12 with which it can be screwed into an extruder housing. In the feeding direction, the extruder insert 11 tapers with a cone-shaped funnel 13 up to a point of smallest diameter 14, followed by an annular stage that ends in a cylindrical bore 15, serving as the exit opening of the extruder. The extruder insert 11 may also be referred to as extruder nozzle. However, the invention also includes different designs of the extruder insert 11.

The extruder 16 as proposed by the invention, shown in FIG. 3, has an extruder housing 17 in form of a cylindrical tube in which the extruder screw 1 rotates. In front, relative to the feeding direction, a cylindrical flange 18 is screwed to the extruder housing 17 that serves to attach the extruder 16 to a rotary drive system (not shown). The feed screw 3 of the extruder screw 1 is located inside the cylindrical flange 18.

The chopping screw 4 is located in that part of the extruder housing 17 consisting of the cylindrical tube. The extruder 16 has a heater in form of a heater coil 20 surrounding the extruder housing 17. The extruder insert 11 is screwed into the extruder housing 17 with axial spacing from the rear surface 10 of the extruder screw 1. This creates a smoothing space 21 in the extruder housing 17 between the extruder screw 1 and the extruder insert 11. Due to the feature that the diameter of the core 9 of the extruder screw 1 increases in the feeding direction in the area of the screw thread 6 that comes first in relation to the feeding direction and of the buffer zone 8, the gap between the core 9 of the extruder screw 1 and the extruder housing 17 decreases in both areas.

For extrusion, a rotary motion is applied to the drive shaft 2 of the extruder screw 1, it feeds the synthetic material to be extruded—supplied as wire or also as granulate—by means of the feed screw 3 to the chopping screw 4 where the synthetic material is chopped into pieces. From the chopping screw 4, the pieces of synthetic material reach the screw thread 6 that comes first in relation to the feeding direction where the synthetic material is compressed, kneaded, and partially plasticized. At the end of the screw 6 that comes first in relation to the feeding direction, the supplied pieces are still recognizable, but already partially fused to each other. In the buffer zone 8, the synthetic material is further compressed which causes gas to be expelled from the synthetic material against the feeding direction. The displaced gas exits at the feed opening from the extruder 16. The screw thread 7 that comes last in relation to the feeding direction plasticizes, mixes, and kneads the synthetic material, and homogenizes it. The gas previously contained in the synthetic material has by now been expelled completely against the feeding direction. At the exit of the screw thread 7 that comes last in relation to the feeding direction, the plasticized synthetic material leaves the extruder screw 1 and enters the smoothing space 21. Here, the synthetic compound is smoothed and mixed some more. The funnel-shaped taper 13 of the extruder insert 11 backs up the plasticized synthetic material, thus generating sufficient counter pressure for plasticizing and degassing the synthetic material in the buffer zone 8. Finally, the synthetic material exits from the extruder insert 11. In the smoothing space 21 and in the funnel-shaped taper 13 of the extruder insert 11 a further homogenization of the plasticized synthetic material takes place.

The extruder 16 shown here is a hand-held device for welding thermoplastic synthetic material, i.e. a hand-held extrusion welding device.

In the design variant shown here, the extruder 16 has an exterior diameter of the screw threads 6, 7 and an interior diameter of the extruder housing 17 of 16 to 17 mm. A compression zone, i.e. the screw thread 6 that comes first in relation to the feeding direction, has a length that corresponds to the diameter, or is slightly longer. At 35 to 50 mm, the buffer zone 8 is distinctly longer, with its length preferably being closer to the specified lower limit. The compression chamber 21 has a length of approximately 25 mm; at its narrowest spot 14, the extruder insert 11 has a diameter of approximately 5 to 6 mm. The dimensions given here are examples, and may be varied more or less in different design variants of the invention.

1. An extruder, specifically an extrusion welding device, with an extruder housing and a power-driven extruder screw rotating in the extruder housing, characterized by the feature(s) that the extruder screw has two axially spaced screw threads.

2. An extruder according to claim 1, wherein a gap between the extruder housing and a core of the extruder screw becomes smaller in feeding direction.

3. An extruder according to claim 2, wherein the gap becomes smaller in the feeding direction in the area of the screw thread that comes first in relation to the feeding direction and/or in the zone between the two screw threads.

4. An extruder according to claim 2, wherein the gap is constant in the area of the screw thread that comes last in relation to the feeding direction.

5. An extruder according to claim 2, wherein the diameter of a core of the extruder screw increases in the feeding direction of the extruder in the area of the diminishing gap between the core and the extruder housing.

6. An extruder according to claim 1, wherein a smoothing space is located in the extruder between the extruder screw and an extruder insert.

7. An extruder according to claim 6, wherein the smoothing space is free of obstructions.

8. An extruder according to claim 1, wherein the extruder has an extruder insert with a funnel-shaped taper in feeding direction.

9. An extruder according to claim 8, wherein the extruder insert has no dead zone in the area of its funnel-shaped taper.

10. An extruder according to claim 1, wherein the extruder is a hand-held device.

11. An extruder according to claim 3, wherein the gap is constant in the area of the screw thread that comes last in relation to the feeding direction.

12. An extruder according to claim 3, wherein the diameter of a core of the extruder screw increases in the feeding direction of the extruder in the area of the diminishing gap between the core and the extruder housing.

13. An extruder according to claim 4, wherein the diameter of a core of the extruder screw increases in the feeding direction of the extruder in the area of the diminishing gap between the core and the extruder housing.

14. An extruder according to claim 2, wherein a smoothing space is located in the extruder between the extruder screw and an extruder insert.

15. An extruder according to claim 3, wherein a smoothing space is located in the extruder between the extruder screw and an extruder insert.

16. An extruder according to claim 14, wherein the smoothing space is free of obstructions.

17. An extruder according to claim 15, wherein the smoothing space is free of obstructions.

18. An extruder according to claim 2, wherein the extruder has an extruder insert with a funnel-shaped taper in feeding direction.

19. An extruder according to claim 3, wherein the extruder has an extruder insert with a funnel-shaped taper in feeding direction.
